(19) United States
(12) Patent Application Publication
(10) Pub. No.: US 2011/0154594 A1
(43) Pub. Date: Jun. 30, 2011

(54) Tool for Working on Repaired Underground Pipes

(76) Inventor: Ira Kozak, Riverwoods, IL (US)

(21) Appl. No.: 13/060,557

(22) PCT Filed: Aug. 25, 2009
(86) PCT No.: PCT/US2009/054890

§ 371 Date: Feb. 24, 2011

(51) Int. Cl. F16L 55/28

(52) U.S. Cl. 15/104.095

(57) ABSTRACT

A tool for working on a repaired underground pipe that has a working end, a driving end, and a plurality of flexible shaft capable of transmitting a rotary force from the driving end to the cutting end.

### RELATED APPLICATIONS

This application claims priority to U.S. Provisional Application No. 61/091,686 file Aug. 25, 2008, the entirety of which is herein incorporated as if full set forth herein.

### TECHNICAL FIELD

The present invention relates generally to devices used for working on repaired underground pipes.

### BACKGROUND

Underground pipes may be repaired in the following manner: a fabric coated with a resin (or a similar type hardening liquid) is inserted into a pipe at an exposed end; an inflatable device, similar to a balloon, is inserted into the fabric running the length of the pipe; and, the inflatable device is inflated, allowing the liquid in the fabric to set.

The repaired underground pipe may untimely include obstructions from the fabric and/or dried liquid that was used to repair the pipe. Any obstructions that remain could act to cause debris and other material to collect and, in turn, could cause a blockage in the pipe. However, since the pipe is located underground (or is otherwise inaccessible) it may be difficult to remove the obstruction safely without damaging the pipe and, specifically, the repaired portion of the pipe.

While devices may already exist, it is believed that there remains a need in the art for a device that can be inserted into the repaired underground pipe at an exposed point (such as an open end), but allow a user to work on the underground pipe at a non-exposed point.

### BRIEF SUMMARY

It is an object of the present invention to provide a device that can be inserted into the repaired underground pipe at an exposed point and allow a user to work on, for example to cut, the repaired underground pipe at a non-exposed point. This would be beneficial because it would allow a user to repair the pipe rather than the more costly, time consuming and destructive method of digging up and removing the pipe.

It is also an object of the present invention to provide a device that can be inserted into an exposed point of the repaired underground pipe and be manipulated through the repaired underground pipe, including around bends. This is believed to be beneficial because a majority of pipes include bends and other undulations.

It is also an object of the present invention to prove a device that is comprised of a plurality of flexible shafts, connecting together. This is believed to be beneficial because a user could select the appropriate amount of flexible shafts for the distance that is needed to be traveled. This would, in some instances, minimize the amount of materials brought to the job and/or work site.

These and other objects of the invention will be readily apparent from the following detailed description.

Moreover, it is contemplated that the device described herein would have other uses than the specific use described herein.

Furthermore, the embodiments disclosed herein may be described as different embodiments, with different features. However, nothing is meant that the described device only include those certain embodiments or those specific features. Rather, it is contemplated that certain features may be present in certain embodiments, even though the embodiment is not described with same.

### BRIEF DESCRIPTION OF THE SEVERAL VIEWS OF THE DRAWINGS

The present invention will become more fully apparent from the following description and appended claims, taken in conjunction with the accompanying drawings. Understanding that the accompanying drawings depict only typical embodiments, and are, therefore, not to be considered to be limiting of the scope of the present disclosure, the embodiments will be described and explained with specificity and detail in reference to the accompanying drawings as provided below.

FIG. 1 is a top view of an embodiment of the tool in accordance with the present invention.

FIG. 2 is a top view of another embodiment of the tool in accordance with the present invention.

FIG. 3 is a front perspective view of a flexible shaft used in accordance with the present invention.

### DETAILED DESCRIPTION

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

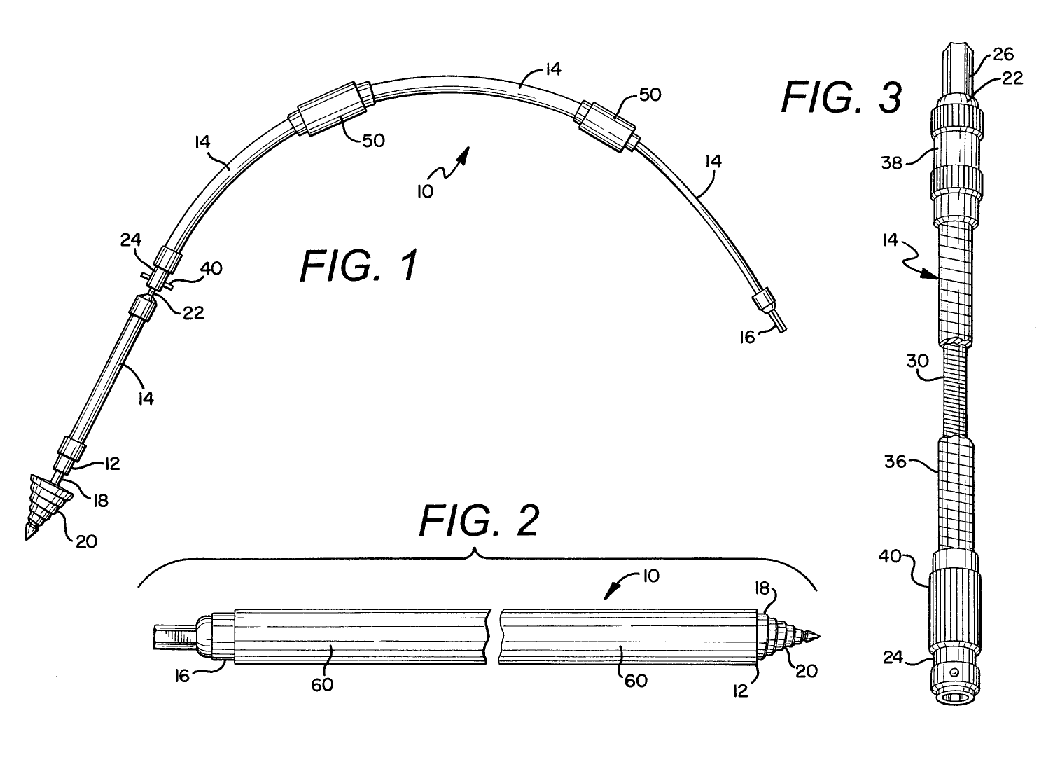

In the illustrations given and more particular in FIGS. 1 and 2, the reference numeral 10 designates generally a device or tool for working on a repaired underground pipe. The device 10 includes a working end 12, a plurality of flexible shafts 14, and a driving end 16.

The working end 12 includes a rotary cutting tool 18. The rotary cutting tool 18 may be, for example, a step bit 20, or another appropriate cutting device, such as a u-shaped razor blade, two prongs, drill bit, or other rotary cutting tool implement.

Each flexible shaft 14 includes a male connection 22 and a complementary configured female connection 24. These connections 22, 24 allow the shafts 14 to be connected to: each other to allow the appropriate number of shafts 14 to be connected; the rotary cutting tool 18; and, a device to impart rotary motion (not shown). For these reasons, it is preferred that the connections include a hexagonal configuration 26. Known and contemplated connecting structures include, but are not limited to, a ball and detent, a magnet, and drill pin 40, quick release, compression springs and any of the other structures known in the art.

It is also contemplated that the flexible shaft 14 include a first end portion 38 and a second end portion 40 with a flexible sleeve 36 disposed in between the first end portion 38 and the second end 40. In addition, it is contemplated that the flexible shaft includes a plurality of wires 30 disposed within the flexible sleeve 36 and be connected to the male connection 22 and female connection 24. It is preferred that the plurality of wires 30 is able to transmit rotary force in both a clockwise and a counterclockwise direction.

The flexible shaft 14 allows the device 10 to flex and bend, while also transmitting a rotary force to the working end 12. The rotary force is applied by, for example, a cordless power drill. For example, the driving end 16 may be inserted into the chuck of the cordless power drill. When rotated, the flexible shaft 14 transmits the rotary force (applied to the driving end 16) to the working end 12—which in turn rotates the rotary cutting tool 18 and allows a user to work on the repaired underground pipe, for example, by allowing the user to cut away obstructions from the repair process on the walls of the pipe.

It is contemplated that the flexible shaft 14 is the Flex-A-Bit®, available from Eazypower, in Chicago, Ill., as described in U.S. Pat. No. 4,876,929, the entirety of which is incorporated herein by reference.

It is also contemplated that a collar 50 is disposed over the connection point formed between a male connection 22 and a female connection 24 of adjacent flexible shafts 14. The collar 50 will protect the pipe from damage and accidentally being exposed to the male connection 22 and female connection 24 underneath the collar 50. In addition, the collar 50 protects the male connection 22 and female connection 24 from any objects that might otherwise interfere with the transmission of the rotary motion.

In another embodiment, instead of, or in addition to a collar 50, the device 10 may include a hose cover 60 over the plurality of flexible shafts 14 and/or over a portion of the rotary cutting tool 18. This is believed to allow for easier insertion into a repaired underground pipe, and may minimize any damage to the walls of the repaired underground pipe. It is contemplated that the hose cover 60 be comprised of polyethylene. It is contemplated that in the embodiment where the hose cover 60 is disposed over a portion of the cutting tool 18, that the cover be able to be retracted (towards the driving end 16) to exposed the cutting tool 18 to the portion of the pipe to be worked on.

Without further elaboration, it is believed that one skilled in the art can use the preceding description to utilize the present disclosure to its fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles of the disclosure provided herein. In other words, various modifications and improvements of the embodiments specifically disclosed in the description above are within the scope of the appended claims. Note that elements recited in means-plus-function format are intended to be construed in accordance with 35 U.S.C. §1129¶6. The scope of the invention is therefore defined by the following claims.

1. A device for working on a repaired underground pipe, the device comprising:
a working end having a rotary cutting tool,
a driving end, and,
a plurality of flexible shafts, each shaft including a male connection and a female connection and being capable of transmitting a rotary force from the driving end to the working end.

2. The device of claim 1 wherein the rotary cutting tool is a step drill bit.

3. The device of claim 1 further comprising a collar being disposed over a female connection of a first flexible shaft and a male connection of a second flexible shaft, wherein the first flexible shaft and second flexible shaft are adjacent.

4. The device of claim 1 wherein the male connection and female connection of each flexible shaft has a hexagonal configuration.

5. The device of claim 1 wherein the flexible shaft includes a plurality of wires disposed within a flexible housing, wherein the plurality of wires are connected to the male connection and female connection.

6. The device of claim 1 further comprising a hose cover disposed over a portion of the plurality of flexible shafts.

7. The device of claim 6 wherein the hose cover is further disposed over a portion of the rotary cutting tool.

8. The device of claim 1 further comprising a hose cover disposed over a portion of the rotary cutting tool.

9. The device of claim 7 wherein the hose cover is retractable.

10. The device of claim 6 wherein the hose cover is polyethylene.

11.-12. (canceled)
